(19) United States
(12) Patent Application Publication
(10) Pub. No.: US 2025/0344635 A1
(43) Pub. Date: Nov. 13, 2025

(54) LAWN MOWER HEIGHT-OF-CUT SYSTEM WITH INTEGRAL STRIPING ROLLER

(71) Applicant: THE TORO COMPANY, Bloomington, MN (US)

(72) Inventors: Chadwick A. Shaffer, Oakdale, MN (US); Patrick J. Shaver, Woodbury, MN (US)

(21) Appl. No.: 18/871,299

(22) PCT Filed: Jun. 20, 2023
(86) PCT No.: PCT/US2023/025729

§ 371 Date: Dec. 3, 2024

Related U.S. Application Data
(60) Provisional application No. 63/357,306, filed on Jun. 30, 2022.

(51) Int. Cl. A01D 34/74; A01D 34/69; A01D 101/00

(52) U.S. Cl. CPC A01D 34/74; A01D 34/69; A01D 2101/00

(57) ABSTRACT

A power lawn mower having a height-of-cut (HOC) system adapted to adjust a height of a cutting blade of the mower relative to a ground surface upon which the mower operates by adjusting the vertical position of two wheels of the mower relative to a chassis of the mower. The HOC system may include a transverse connecting rod that allows movement of a single HOC control to simultaneously change the vertical position of both wheels throughout an HOC range. A lowermost portion of the connecting rod may remain at an elevation below a cutting plane of the cutting blade (and/or below lower surfaces of the chassis) regardless of the position of the cutting blade within the HOC range to provide a grass striping effect.

This application claims priority to and/or the benefit of U.S. Provisional Patent Application No. 63/357,306, filed 30 Jun. 2022, which is incorporated herein by reference in its entirety.

Embodiments of the present disclosure are directed to lawn mowers and, more particularly, to a height-of-cut system with an integral grass striping roller.

### BACKGROUND

Outdoor power equipment units such as lawn mowers and the like are well known to both professionals and homeowners alike. Professional lawn mowers sometimes incorporate a system that allows grass striping. Striping is a grooming procedure used to orient grass to achieve a particular aesthetic effect. For example, striping is commonly used in professional ballparks to create a turf surface having a checkerboard or plaid appearance. Today, golf courses, municipal parks, and, to a lesser extent, homeowners, seeking to obtain a more manicured and professional lawn appearance are also incorporating striping techniques into their lawn care activities.

In general, the striping effect may be achieved by bending blades of grass in controlled directions. An area of grass bent away from an observer, for example, may appear to be a different shade than a grass area bent toward the observer. Often, a first strip or path of grass is bent in a first direction, while the immediately adjacent strip is bent in the opposite direction. This pattern may be repeated across an entire turf surface to achieve the desired effect.

### SUMMARY

Embodiments of the present disclosure may provide a power lawn mower that includes: a mower chassis supporting a cutting deck containing at least one rotary cutting blade, the chassis defining a lower chassis plane and a travel axis; and two wheels operatively connected to the mower chassis and adapted to support a rear portion of the mower chassis in rolling engagement with a ground surface, wherein the two wheels include a first wheel located on a first side of the mower chassis, and a second wheel located on an opposite, second side of the mower chassis. The mower may also include a height-of-cut (HOC) system adapted to adjust a height of the two wheels simultaneously relative to the mower chassis, thereby adjusting an elevation of the cutting blade relative to the ground surface between a maximum HOC position and a minimum HOC position. The HOC system may include first and second bellcranks associated with the first and second wheels, respectively, wherein each bellcrank is pivotally coupled to the mower chassis such that each pivots about a common pivot axis extending transverse to the travel axis, and wherein each of the first and second bellcranks includes: a first end spaced-apart from the common pivot axis and adapted to support a wheel axle of its associated first or second wheel; and a second end also spaced-apart from the common pivot axis. The HOC system may also include a connecting rod connecting the second ends of the first and second bellcranks such that pivotal motion of the first bellcrank about the common pivot axis produces corresponding pivotal motion of the second bellcrank about the common pivot axis. The first and second bellcranks are pivotable between a first position corresponding to the maximum HOC position, and a second position corresponding to the minimum HOC position, wherein an uppermost portion of the connecting rod is positioned at an elevation at or below the lower chassis plane when the first and second bellcranks are at the first position, the second position, and any position between the first and second positions.

In another embodiment, a power lawn mower may be provided that includes: a mower chassis supporting a cutting deck containing at least one rotary cutting blade, the blade defining a cutting plane; and two wheels operatively connected to the mower chassis and adapted to support the mower chassis in rolling engagement with a ground surface, wherein the two wheels include a first wheel located on a first side of the mower chassis, and a second wheel located on an opposite, second side of the mower chassis. The mower may also include a height-of-cut (HOC) system adapted to adjust a height of the two wheels simultaneously relative to the mower chassis, thereby adjusting an elevation of the cutting blade relative to the ground surface in an HOC range between a maximum HOC position and a minimum HOC position. The HOC system may include first and second bellcranks located proximate the first and second wheels, respectively, wherein both of the bellcranks are pivotally coupled to the mower chassis such that both pivot about a common pivot axis extending transverse to a travel axis of the chassis, wherein each of the first and second bellcranks includes: a first end spaced-apart from the common pivot axis and adapted to support a wheel axle of its associated first or second wheel; and a second end also spaced-apart from the common pivot axis. The HOC system further includes a connecting rod connected to the second ends of the first and second bellcranks such that pivotal motion of the first bellcrank about the common pivot axis produces corresponding pivotal motion of the second bellcrank about the common pivot axis. The first and second bellcranks may be pivotable between a first position corresponding to the maximum HOC position, and a second position corresponding to the minimum HOC position, wherein a lowermost portion of the connecting rod remains at an elevation between an elevation of the cutting plane and an elevation of the ground surface regardless of the position of the cutting blade within the HOC range.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is right rear perspective view of a lawn mower incorporating a height-of-cut (HOC) system in accordance with embodiments of the present disclosure;

FIG. 2 is a right rear view of an exemplary chassis of the mower of FIG. 1;

FIG. 3 is an isolated perspective view of an HOC system in accordance with embodiments of the present disclosure, the HOC system including a front HOC system and a rear HOC system;

FIG. 4 is a perspective view of the rear HOC system of FIG. 3;

FIG. 5 is a partial exploded view of the rear HOC system of FIG. 3 illustrating a connecting rod forming a grass striping member;

FIG. 6 is a diagrammatic side elevation view illustrating the HOC system and grass striping member at an intermediate HOC setting;

FIG. 7 is a diagrammatic side elevation view similar to FIG. 6 but showing the HOC system and grass striping member at a maximum HOC setting; and

FIG. 8 is a diagrammatic side elevation view similar to FIG. 6 but showing the HOC system and grass striping member at a minimum HOC setting.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. The term “i.e.” is used as an abbreviation for the Latin phrase id est and means “that is.” The term “e.g.” is used as an abbreviation for the Latin phrase exempli gratia and means “for example.”

Generally speaking, embodiments of the present disclosure may be directed to a height-of-cut (HOC) system to adjust a cutting height of a chassis defining a deck (e.g., a cutting deck) of a power ground working vehicle (e.g., a self-propelled walk-behind power lawn mower). In some embodiments, the mower may include a rotary cutting blade contained within the deck, and two rear wheels (one on each lateral side of the deck), wherein each rear wheel is operatively attached to the chassis via an associated bellcrank that is pivotally attached to the chassis. A connecting rod (e.g., transversely extending connecting rod) may extend between the two bellcranks such that adjustment of the height-of-cut of one wheel produces a corresponding height-of-cut adjustment to the opposite wheel. The construction of the bellcranks and connecting rod may allow a lower portion of the connecting rod to remain, at all HOC positions, below a cutting plane formed by the cutting blade. As the lower portion is effectively below the cutting plane, the connecting rod extends into the cut grass blades and thus may advantageously provide a striping member for striping grass during mower operation.

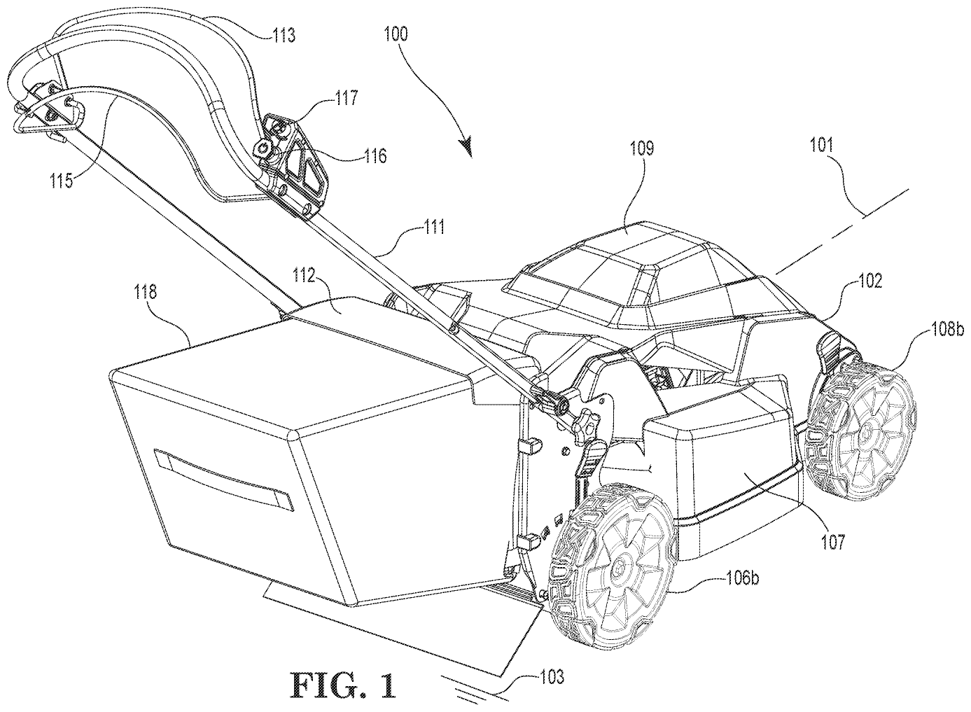

With reference to the figures of the drawing, wherein like reference numerals designate like parts and assemblies throughout the several views, FIG. 1 illustrates a ground working vehicle in accordance with exemplary embodiments of the present disclosure. While shown in this view as a self-propelled, ground working vehicle 100, e.g., a walk-behind power lawn mower (also referred to herein simply as a “machine” or “mower”), such a configuration is not limiting as aspects of the present disclosure may find application to other ground working machines and implements.

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the mower 100 is in an operating configuration (e.g., while the mower is positioned such that wheels 106 and 108 rest upon a generally horizontal ground surface 103 as shown in FIG. 1). These terms are used only to simplify the description, however, and not to limit the interpretation of any embodiment described. In a similar manner, terms such as “first” and “second” may be used herein to describe various elements. However, such terms are provided merely to simplify identification of the element(s). Accordingly, if an element is described as “first,” there may or may not be any other subsequent elements—that is, a “second” element is not necessarily present. It is further understood that the description of any particular element as being operatively attached, connected, or coupled to another element may indicate that the elements are either directly attached, connected, or coupled to one another, or are indirectly attached, coupled, or connected to one another via intervening elements.

Still further, the suffixes “a” and “b” may be used throughout this description to denote various left-and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

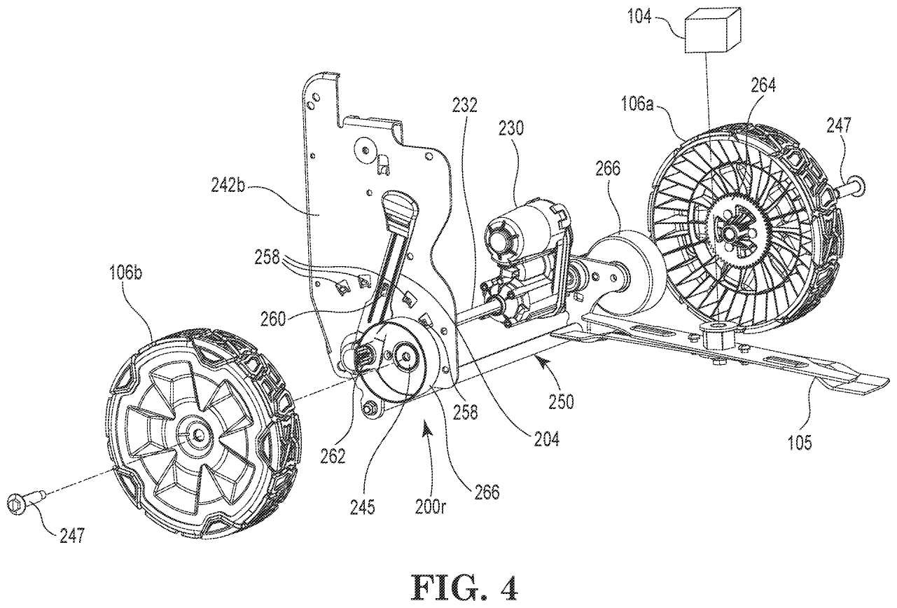

While the general construction of the mower is not necessarily central to an understanding of the present disclosure, an exemplary mower 100 is shown in FIG. 1 and described below. As illustrated in FIG. 1, the mower 100 may include a mower chassis 102 that defines and supports a cutting deck 107 containing at least one powered rotary cutting blade 105 (e.g., the deck may define a cutting chamber in which the rotary cutting blade (see. FIG. 4) is positioned). The chassis 102 may further carry one or more prime movers adapted to rotate the cutting blade and/or one or both of the rear wheels 106. While the prime mover(s) may be configured as most any power unit (e.g., an internal combustion engine, an electric motor, etc.), embodiments illustrated herein may utilize a battery-powered electric blade motor 104 (represented diagrammatically in FIG. 4) to power the cutting blade 105, and a separate electric propulsion motor 230 (see also FIG. 4) to power one or more of the rear wheels 106 as further described below to propel the mower along a travel axis 101 defined by the mower 100/chassis 102.

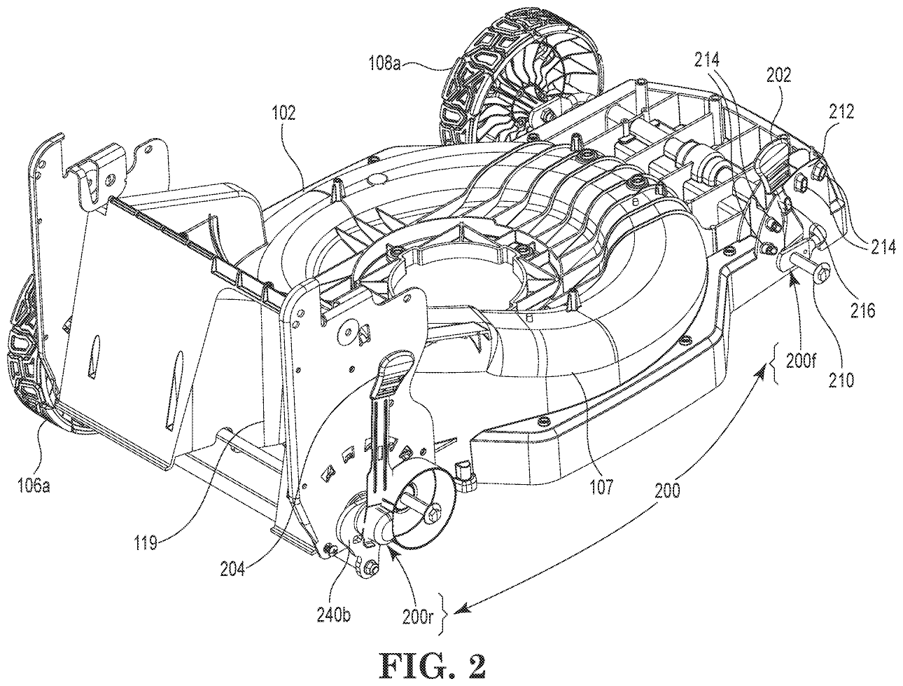

The chassis 102 may be supported in rolling engagement upon the ground surface 103 by ground-engaging members that, in one embodiment, include two rear wheels 106 (only right (second) rear wheel 106b visible in FIG. 1, but see left (first) rear wheel 106a in FIG. 2) operatively connected to the mower chassis 102, e.g., coupled to left and right sides of a rear portion of the mower 100. That is to say, a first (e.g., left) wheel 106a is located on a first (e.g., left) side of the chassis 102, while a second (e.g., right) wheel 106b is located on an opposite second (e.g., right) side of the chassis. The rear wheels may be adapted to support a portion (e.g., rear portion) of the mower chassis 102 in rolling engagement with the ground surface 103.

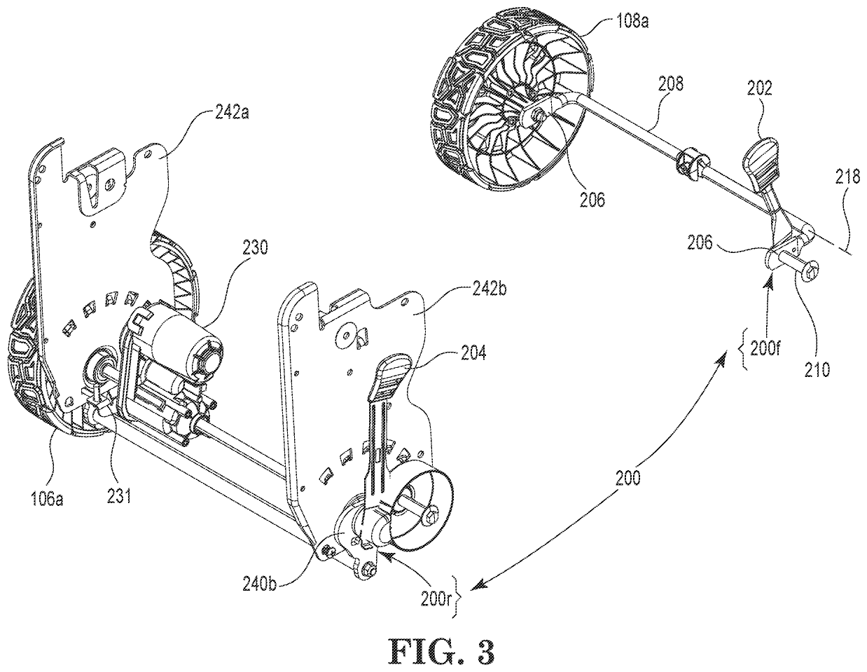

The rear wheels 106 may be powered either by the blade motor (e.g., via a transmission or the equivalent), or as further described below, by the separate electric propulsion motor 230 (see FIG. 4) adapted to drive the rear (drive) wheels 106 so that the rear wheels 106 may rotate (relative to the chassis 102) and selectively propel the mower 100 over the ground surface 103. In some embodiments, the propulsion motor 230 (which may be secured to the chassis by one or more brackets 231 as shown in FIG. 3) may function as a variable speed transmission that selectively rotates at least one of the rear wheels 106 in proportion to an operator-selectable speed control input. As further shown in the figures, a pair of unpowered front ground-engaging members (e.g., front wheels 108a (see FIG. 2), 108b) may support a front portion of the mower 100 in rolling engagement with the ground surface 103. Of course, other drive configurations (e.g., front wheel or all-wheel drive) and other types of ground-engaging members (e.g., tracks, rollers, etc.) located at any suitable position on the chassis 102 (e.g., front, back, etc.), are also contemplated.

To power the various electric motors of the mower 100, one or more battery packs (not shown) may be carried by the chassis 102. In some embodiments, the battery pack(s) may be permanently attached (e.g., re-charged while onboard), while in other embodiments, the battery pack(s) may be removably installed on the chassis (e.g., inserted into a receiver of the chassis, e.g., beneath the cover 109 in FIG. 1). In still other embodiments, power may be provided by a cord connected to a remote AC or DC power source. As used herein battery “pack” may refer to a battery unit having one or more individual battery cells contained therein that, in some embodiments, have a lithium-based chemistry (e.g., lithium-ion). Other embodiments may utilize batteries of other chemistries, or other power source technologies (e.g., solar power, fuel cell, etc.) altogether.

As with conventional walk behind lawn mowers, the mower 100 may also include an upwardly and rearwardly extending operator handle assembly 111 connected to the chassis 102 and having one or more controls located thereon. The controls may permit an operator to control various mower functions from a walking position behind the mower. For example, the controls may include a series of bails 113, 115 that allow energization of the various electric motors. Other controls may include an ignition switch 116 (e.g., to selectively allow the bails to energize the motors) and a speed control (e.g., knob 117) adapted to vary the speed of the electric propulsion motor. Of course, such controls are exemplary only and mowers lacking such controls (e.g., in the case of autonomous mowers), and/or mowers including controls of a different configuration, are also contemplated.

The mower 100 may optionally include a grass catcher or “bag” 118. The bag 118 may be attached to the chassis 102 such that it fluidly communicates with a discharge channel 119 (see FIG. 2) formed by the chassis. The bag 118 may capture and hold grass clippings cut by the mower during operation. In some embodiments, the bag 118 may be removed from the chassis 102 and a mulching plug (not shown) inserted into the channel 119 to block discharge during mulching operation of the mower. A door 112 (see FIG. 1) may also be closed over the channel 119 when the bag 118 is removed.

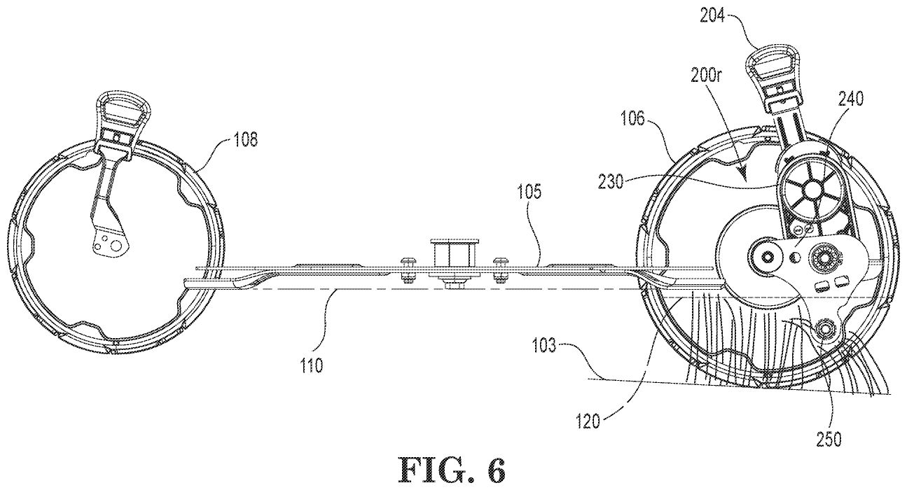

As shown in FIGS. 2-4, the mower 100 may also include a height-of-cut (HOC) system 200. The HOC system 200 is adapted to adjust a height of the cutting deck 107 (and, therefore, a cutting plane 110 (see FIG. 6) defined by the cutting blade 105) relative to the ground surface 103 to allow the operator to select a suitable cut grass length. As described herein, the HOC system 200 may include a rear HOC system 200r adapted to adjust a height of a rear axle (e.g., simultaneously adjust a height of (i.e., raise or lower) the two rear wheels 106) relative to the mower chassis, and a front HOC system 200f adapted to adjust a height of a front axle (e.g., simultaneously adjust a height of (i.e., raise or lower) the two front wheels 108) relative to the mower chassis. Stated another way, the HOC setting of both front wheels 108 may be adjusted simultaneously, e.g., via a lever 202, while the HOC setting of both rear wheels 106 may be adjusted simultaneously, e.g., via another lever 204. Such a configuration may be referred to as a dual-point HOC system. While not illustrated, embodiments of the present disclosure may also find application to single-point HOC systems wherein all of the ground engaging members (e.g., wheels 106, 108) are simultaneously adjusted to change the height of the cutting deck relative to the ground surface 103 via interaction with a single control.

The front HOC system 200f may include the lever 202 as shown in FIGS. 2 and 3. The lever 202 is fixed to a protruding ear 206 that is itself fixed to a transverse axle shaft 208 (an ear 206 may be provided at each end of the axle shaft as shown in FIG. 3). Each ear 206 may include a threaded opening adapted to receive a wheel axle 210 (e.g., fastener such as a shoulder bolt) that supports the associated front wheel 108 for rotation relative to the ear 206.

The lever 202 may be biased against a front adjustment plate 212 as shown in FIG. 2. The front adjustment plate 212 may include a series of protrusions 214 operable to engage an opening 216 formed in the lever 202. To adjust the HOC setting of the front wheels 108, the operator may displace the lever 202 away from the front adjustment plate 212 sufficiently to disengage the protrusion 214 from the opening 216, after which the lever may pivot the axle shaft 208 (including the ears 206/wheel axle 210) about an axle shaft axis 218 (see FIG. 3). Such pivotal motion of the lever 202 results in the front wheels effectively moving (simultaneously) vertically relative to the chassis 102. Once the opening 216 is aligned with the appropriate protrusion 214, the displacing force applied to the lever 202 may be released, whereby the lever is again biased toward the front adjustment plate 212 such that the opening 216 may receive the protrusion 214 corresponding to the selected height-of-cut.

Like the front HOC system 200f, the rear HOC system 200r may be adapted to simultaneously raise and lower the two rear wheels 106 relative to the chassis 102 to, like the front HOC system 200f, adjust an elevation of the chassis 102/cutting blade 105/cutting plane 110 relative to the ground surface 103 between a maximum HOC position and a minimum HOC position as further described below.

The rear HOC system 200r may also include a lever (e.g., the lever 204). Unlike the front HOC system 200f however, the rear HOC system 200r is designed to further accommodate operation of a propulsion system (e.g., propulsion motor 230) adapted to drive the rear wheels 106.

With reference to FIGS. 3, 4, and 5, the rear HOC system 200r may include first and second bellcranks 240 (e.g., left bellcrank 240a and right bellcrank 240b) associated with the first (left) and second (rear) wheels 106, respectively. Each bellcrank 240 comprises an opening 241 to accommodate passthrough of a drive axle 232 (first or left drive axle 232a, and second or right drive axle 232b) that is driven by the propulsion motor 230 (a differential 233 may be operatively positioned between the propulsion motor and the axles to allow differential rear wheel rotation (e.g., turning)). Each bellcrank is further pivotally coupled to the chassis 102 (e.g., the first (left) and second (right) bellcranks 240 are pivotally coupled to associated rear first and second adjustment plates 242, respectively) such that each bellcrank pivots about a common pivot axis 243 extending transverse to the travel axis 101 (see FIG. 1) of the mower/chassis 102. As is evident in the figures, the common pivot axis 243 may be coaxial with an axis of each drive axle 232.

Each bellcrank 240 may include a radially-extending first leg 244 and a radially-extending second leg 246 such that each bellcrank forms a generally L-shaped member. The first leg 244 may define a first end spaced-apart from the common pivot axis 243, wherein the first end forms a receiver 245 adapted to support a wheel axle 247 (e.g., formed by a fastener such as a shoulder bolt) of its associated rear wheel 106. The second leg 246 may similarly define a second end also spaced-apart from the common pivot axis 243, wherein the second end may include features (e.g., an opening 248) configured to accommodate attachment of a connecting rod 250. That is to say, the connecting rod 250 may connect the second ends of the bellcranks 240a and 240b to one another such that pivotal motion of a first (e.g., right) bellcrank 240b about the common pivot axis 243 produces corresponding pivotal motion of the second (e.g., left) bellcrank 240a about the common pivot axis.

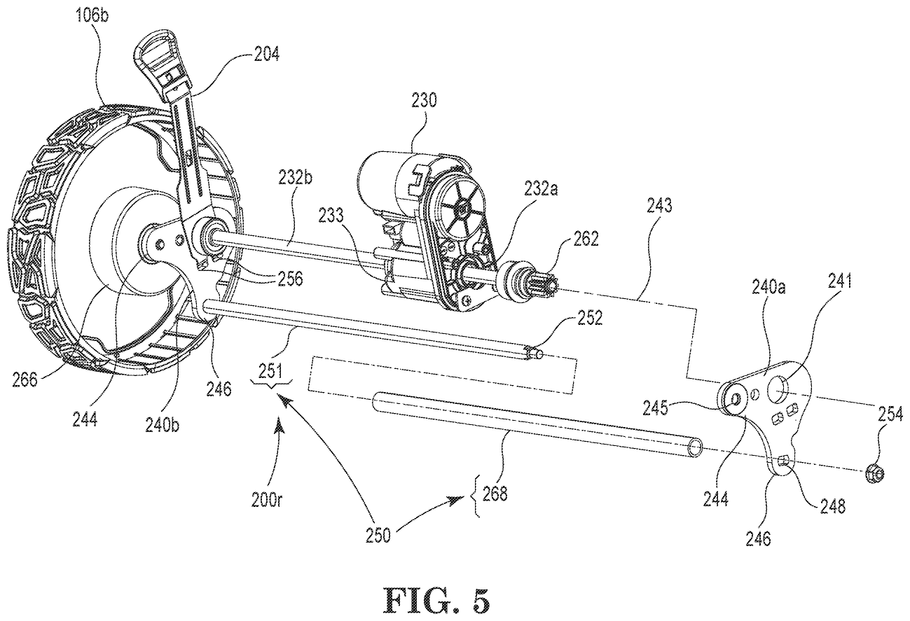

In the illustrated embodiments, ends of the connecting rod 250 may include one or more flats 252 (e.g., a “double-D” configuration as shown in FIG. 5) that are received in the respective openings 248 (each of which has a shape corresponding to the flats 252) such that relative rotation between the connecting rod and the bellcranks is restricted. A nut 254 may then thread to each end of the connecting rod 250 to secure the rod to the bellcranks.

The lever 204 may be fixed to one (e.g., the right) bellcrank 240 such that pivotal motion of the lever causes the bellcrank to pivot about the axis 243. As indicated in FIG. 5, the bellcrank 240b may include features (e.g., openings 256) adapted to receive ears of the lever 204 so that pivotal motion of the lever may impart corresponding pivotal motion to the bellcrank.

The lever 204 may be biased against the rear adjustment plate 242b as shown in FIG. 4. As with the front adjustment plate 212, the rear adjustment plate 242b may include a series of protrusions 258 operable to engage an opening 260 formed in the lever 204. As a result, the operator may adjust the HOC setting of the rear wheels 106 by displacing the lever 204 away from the rear adjustment plate 242b sufficiently to disengage the protrusion 258 from the opening 260 after which the lever may pivot the bellcrank 240b about the common pivot axis 243. As the left bellcrank 240a is connected to the right bellcrank 240b via the connecting rod 250, the left bellcrank may move (pivots) in unison with the right bellcrank.

As the bellcranks 240 pivot, the rear wheels 106 (which are attached to the respective first legs 244 of the bellcranks 240) may effectively move vertically relative to the chassis 102, altering the height-of-cut of the mower 100. In a manner similar to the front HOC system 200f, once the opening 260 is aligned with the appropriate protrusion 258, the separating force applied to the lever 204 may be released, whereby the lever is again biased toward the rear adjustment plate 242b such that the opening 260 may receive the protrusion 258 corresponding to the selected height-of-cut.

In some embodiments, the front and rear adjustment plates may include indicia associated with each HOC setting (with each protrusion 214, 258) to assist the operator in selecting the desired height-of-cut. For example, the indicia may indicate, for each protrusion/HOC setting, an explicit cutting height (e.g., x millimeters or inches), while in other embodiments the protrusions may provide relative cutting height references (e.g., low, medium, high, or A, B, C, . . . x). Regardless, the indicia may correspond between the front and rear adjustment plates so that the HOC setting of the front wheels may be consistently set to match the HOC setting of the rear wheels.

With continued reference to FIGS. 4 and 5, a pinion gear 262 may be attached to outermost ends of each of the drive axles 232. Each pinion gear 262 is adapted to mesh with a ring gear 264 of its associated wheel 106 (see ring gear 264 of left wheel 106a in FIG. 4). A debris shield or cup 266 may be provided to at least partially surround the pinion and ring gears to reduce ingress of dirt and other debris.

As a location of the pinion gears 262 remains fixed relative to the common pivot axis 243, and as a distance between the rotational axes of each pinion gear and its associated ring gears 264 is fixed, changes in the height-of-cut setting of the rear wheels 106 does not alter or interfere with the ability of the propulsion motor 230 to drive the rear wheels. That is to say, the propulsion motor 230 may operate as intended regardless of HOC setting.

In some embodiments (see, e.g., FIG. 3), the bellcranks 240 may be positioned outboard of the rear adjustment plates 242. As a result, upper positions of the connecting rod 250 are constrained by the chassis 102 and/or the plates 242, i.e., an uppermost portion of the connecting rod remains at or below an elevation of a lower chassis plane 120 defined by the chassis (see FIG. 6) as the rear HOC system moves between its full HOC range (the range being defined by maximum and minimum HOC settings/positions). Still further, as describe in more detail below, a lowermost portion of the connecting rod 250 may remain at an elevation below an elevation of the cutting plane 110 (e.g., at an elevation between the elevation of the cutting plane and an elevation of the ground surface) regardless of the position of the cutting blade within the HOC range. While described as locating the bellcranks outboard of the rear adjustment plates, such a configuration is not limiting. That is, other embodiments wherein the bellcranks are located inboard of the adjustment plates (or corresponding chassis structure) are also contemplated.

As used herein, the “lower chassis plane” may be a localized plane (a plane in the immediate vicinity of the connecting rod) defined by a proximate lower surface(s) of the chassis 102 (e.g., of the adjustment plates 242). While referred to as a “plane,” the chassis plane may have a nonplanar shape without departing from the scope of this disclosure.

Due to this connecting rod being below the cutting plane, the connecting rod 250 may also serve as a grass striping member. This functionality is illustrated in FIGS. 6, 7, and 8 which depict side elevation views of isolated portions of the mower when the rear HOC system 200r is in an intermediate HOC position, a maximum HOC position, and a minimum HOC position, respectively. The maximum HOC position and the minimum HOC position may define an HOC range of the mower.

The terms “HOC position,” “HOC setting,” and the like may be used herein to describe not only settings of the rear HOC system 200r, but also to describe the corresponding positions of the chassis/deck, wheels 106, and cutting blade/cutting plane as those components move throughout the HOC range. For example, the maximum HOC position of the cutting blade/cutting plane may refer to the blade/plane position when the HOC system is in the maximum HOC position.

As shown in FIG. 6, the connecting rod 250 is positioned well below the cutting plane 110 (as well as the below the lower chassis plane 120). As a result, the connecting rod may extend into the grass (the grass blades extending upwardly from the actual ground surface 103) and sufficiently bend the grass blades as shown to provide a striping effect as the mower is propelled forwardly. In some embodiments, the connecting rod 250 may be formed by a cylindrical sleeve 268 (see also FIG. 5) rotatable about a core shaft 251. As the sleeve 268 may rotate freely relative to the core shaft 251, it may reduce catching of the connecting rod on ground surface objects (e.g., tree roots) and ground undulations. Moreover, the sleeve 268 may reduce friction between the core shaft 251 and the grass, potentially extending mower (e.g., battery) run time. While not wishing to be bound to any specific material, the sleeve may, in some embodiments, be made of a material selected from steel, aluminum, polypropylene (PP), high density polyethylene (HDPE), and polyvinyl chloride (PVC). These materials are exemplary only as most any sleeve material is contemplated that permits the desired relative rotation about the core shaft. For purposes of this description, the term “connecting rod” 250 may be understood to include the core shaft 251, and-when the optional sleeve is included-both the core shaft and the sleeve 268.

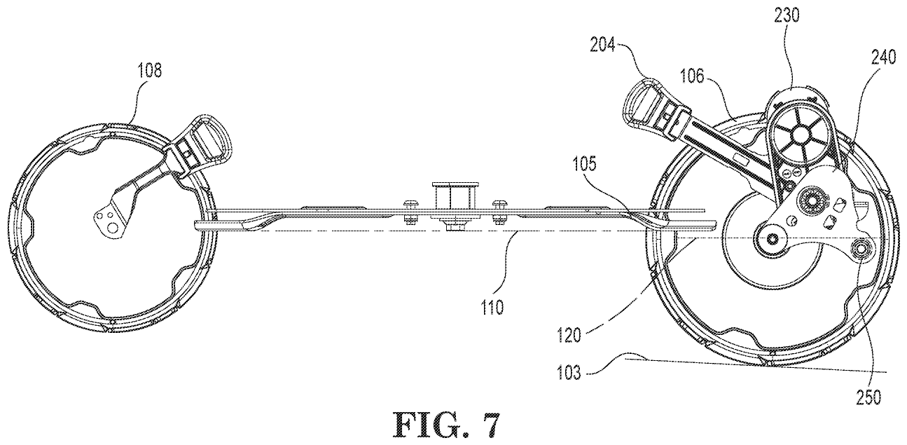

While FIG. 6 shows the rear HOC system at an intermediate HOC setting, FIG. 7 illustrates a similar view but at a maximum HOC setting. In the maximum HOC setting, the bellcranks 240 are in a terminal first position (at one end of the “swing” of the bellcranks) such that the connecting rod 250 is at or near one portion of the lower chassis plane 120. Although not as dramatic as the intermediate HOC setting depicted in FIG. 6, a lowermost portion of the connecting rod 250 remains below the elevation of the cutting plane 110 as shown.

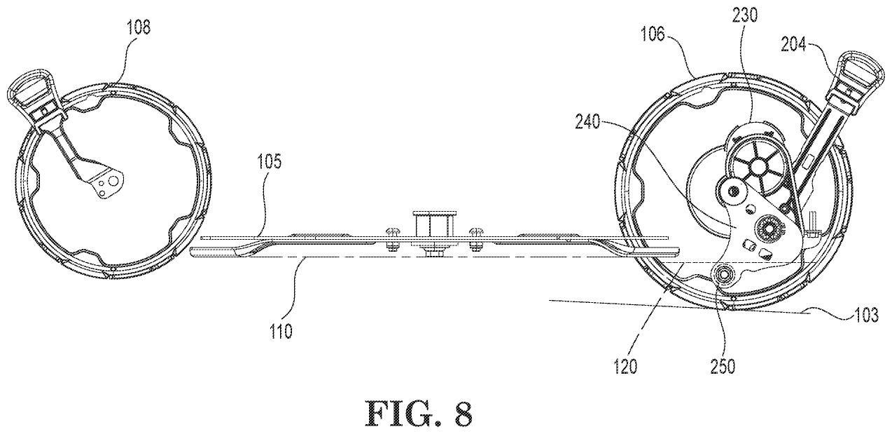

Similarly, FIG. 8 illustrates a view similar to FIGS. 6 and 7, but at a minimum HOC setting. In the minimum HOC setting, the bellcranks 240 are pivoted to an opposite terminal second position (at the opposite end of the “swing” of the bellcranks) such that the connecting rod 250 is at or near another portion of the lower chassis plane 120. As with the maximum HOC setting (as well as any and all intermediate HOC settings), the lowermost portion of the connecting rod 250 remains below the elevation of the cutting plane 110 as shown.

As is visible in FIGS. 6-8, the first and second bellcranks 240a, 240b are thus pivotable between their first positions (corresponding to the maximum HOC position; see FIG. 7) and their second positions (corresponding to the minimum HOC position; see FIG. 8). An uppermost portion of the connecting rod 250 remains, however, positioned at an elevation at or below the lower chassis plane 120 when the first and second bellcranks 240a, 240b are at the first position, the second position, and any position therebetween. As one of skill can appreciate, the connecting rod may thus provide grass striping capability regardless of the HOC setting of the HOC system 200r.

As the bellcranks swing between their first and second positions through the HOC range, the connecting rod 250 may reach a lowermost point or position in its travel. In some embodiments, in this lowermost point within the HOC range, a lowermost portion of the connecting rod may be spaced-apart from the ground surface by a distance of less than 50 millimeters (e.g., less than two inches). Such a distance is exemplary only, however, as other embodiments may be adapted to provide connecting rod heights to suit different applications and mower configurations.

Aspects of the invention are defined in the claims. However, below is provided a non-exhaustive list of non-limiting examples. Any one or more of the features of these examples may be combined with any one or more features of another example, embodiment, or aspect described herein.

Example Ex1: A power lawn mower comprising: a mower chassis supporting a cutting deck containing at least one rotary cutting blade, the chassis defining a lower chassis plane and a travel axis; two wheels operatively connected to the mower chassis and adapted to support a rear portion of the mower chassis in rolling engagement with a ground surface, wherein the two wheels include a first wheel located on a first side of the mower chassis, and a second wheel located on an opposite, second side of the mower chassis; and a height-of-cut (HOC) system adapted to adjust a height of the two wheels simultaneously relative to the mower chassis, thereby adjusting an elevation of the cutting blade relative to the ground surface between a maximum HOC position and a minimum HOC position. The HOC system comprises: first and second bellcranks associated with the first and second wheels, respectively, wherein each bellcrank is pivotally coupled to the mower chassis such that each pivots about a common pivot axis extending transverse to the travel axis, wherein each of the first and second bellcranks comprises: a first end spaced-apart from the common pivot axis and adapted to support a wheel axle of its associated first or second wheel; and a second end also spaced-apart from the common pivot axis; and a connecting rod connecting the second ends of the first and second bellcranks such that pivotal motion of the first bellcrank about the common pivot axis produces corresponding pivotal motion of the second bellcrank about the common pivot axis. The first and second bellcranks are pivotable between a first position corresponding to the maximum HOC position, and a second position corresponding to the minimum HOC position, and wherein an uppermost portion of the connecting rod is positioned at an elevation at or below the lower chassis plane when the first and second bellcranks are at the first position, the second position, and any position between the first and second positions.

Example Ex2: The mower according to Example Ex1, wherein the cutting blade defines a cutting plane, and wherein a lowermost portion of the connecting rod is at an elevation below an elevation of the cutting plane when the cutting blade is at the maximum HOC position, the minimum HOC position, and any position therebetween.

Example Ex3: The mower according to either one of Examples Ex1 or Ex2, wherein the mower chassis further comprises first and second adjustment plates, and wherein the first and second bellcranks are pivotally coupled to the first and second adjustment plates, respectively.

Example Ex4: The mower according to any one of Examples Ex1 to Ex3, wherein the connecting rod comprises both a core shaft and a cylindrical sleeve surrounding the core shaft, the sleeve rotatable about the core shaft.

Example Ex5: The mower according to any one of Examples Ex1 to Ex4, further comprising a prime mover carried by the mower chassis and adapted to rotate the at least one rotary cutting blade.

Example Ex6: The mower according to any one of Examples Ex1 to Ex5, further comprising a prime mover carried by the mower chassis and adapted to rotate one or both of the two wheels.

Example Ex7: The mower according to any one of Examples Ex1 to Ex6, further comprising one or more prime movers carried by the mower chassis and adapted to rotate the at least one rotary cutting blade and one or both of the two wheels.

Example Ex8: The mower according to any one of Examples Ex1 to Ex7, further comprising an upwardly and rearwardly extending operator handle assembly connected to the mower chassis.

Example Ex9: A power lawn mower comprising: a mower chassis supporting a cutting deck containing at least one powered rotary cutting blade, the blade defining a cutting plane; two wheels operatively connected to the mower chassis and adapted to support the mower chassis in rolling engagement with a ground surface, wherein the two wheels include a first wheel located on a first side of the mower chassis, and a second wheel located on an opposite, second side of the mower chassis; and a height-of-cut (HOC) system adapted to adjust a height of the two wheels simultaneously relative to the mower chassis, thereby adjusting an elevation of the cutting blade relative to the ground surface in an HOC range between a maximum HOC position and a minimum HOC position. The HOC system comprises: first and second bellcranks located proximate the first and second wheels, respectively, wherein both of the bellcranks are pivotally coupled to the mower chassis such that both pivot about a common pivot axis extending transverse to a travel axis of the chassis, wherein each of the first and second bellcranks comprises: a first end spaced-apart from the common pivot axis and adapted to support a wheel axle of its associated first or second wheel; and a second end also spaced-apart from the common pivot axis; and a connecting rod connected to the second ends of the first and second bellcranks such that pivotal motion of the first bellcrank about the common pivot axis produces corresponding pivotal motion of the second bellcrank about the common pivot axis. The first and second bellcranks are pivotable between a first position corresponding to the maximum HOC position, and a second position corresponding to the minimum HOC position, and wherein a lowermost portion of the connecting rod remains at an elevation between an elevation of the cutting plane and an elevation of the ground surface regardless of the position of the cutting blade within the HOC range.

Example Ex10: The mower according to Example Ex9, wherein the lowermost portion of the connecting rod is spaced-apart from the ground surface by a distance of less than 50 millimeters when the connecting rod is at a lowermost position within the HOC range.

Example Ex11: The mower according to any one of Examples Ex9 to Ex10, further comprising an electric propulsion motor adapted to drive first and second drive axles each having an axis that is coaxial with the common pivot axis.

Example Ex12: The mower according to Example Ex11, wherein each of the first and second drive axles comprises a pinion gear, and wherein each pinion gear is adapted to mesh with a ring gear of its associated first or second wheel.

Example Ex13: The mower according to any one of Examples Ex11 to Ex12, further comprising a differential operatively positioned between the electric propulsion motor and the first and second axles.

Illustrative embodiments are described, and reference has been made to possible variations of the same. These and other variations, combinations, and modifications will be apparent to those skilled in the art, and it should be understood that the claims are not limited to the illustrative embodiments set forth herein.

1. A power lawn mower comprising:
a mower chassis supporting a cutting deck containing at least one rotary cutting blade, the chassis defining a lower chassis plane and a travel axis;
two wheels operatively connected to the mower chassis and adapted to support a rear portion of the mower chassis in rolling engagement with a ground surface, wherein the two wheels include a first wheel located on a first side of the mower chassis, and a second wheel located on an opposite, second side of the mower chassis;
a height-of-cut (HOC) system adapted to adjust a height of the two wheels simultaneously relative to the mower chassis, thereby adjusting an elevation of the cutting blade relative to the ground surface between a maximum HOC position and a minimum HOC position, wherein the HOC system comprises:
first and second bellcranks associated with the first and second wheels, respectively, wherein each bellcrank is pivotally coupled to the mower chassis such that each pivots about a common pivot axis extending transverse to the travel axis, wherein each of the first and second bellcranks comprises: a first end spaced-apart from the common pivot axis and adapted to support a wheel axle of its associated first or second wheel; and a second end also spaced-apart from the common pivot axis; and
a connecting rod connecting the second ends of the first and second bellcranks such that pivotal motion of the first bellcrank about the common pivot axis produces corresponding pivotal motion of the second bellcrank about the common pivot axis,
wherein the first and second bellcranks are pivotable between a first position corresponding to the maximum HOC position, and a second position corresponding to the minimum HOC position, and wherein an uppermost portion of the connecting rod is positioned at an elevation at or below the lower chassis plane when the first and second bellcranks are at the first position, the second position, and any position between the first and second positions.

2. The mower according to claim 1, wherein the cutting blade defines a cutting plane, and wherein a lowermost portion of the connecting rod is at an elevation below an elevation of the cutting plane when the cutting blade is at the maximum HOC position, the minimum HOC position, and any position therebetween.

3. The mower according to claim 1, wherein the mower chassis further comprises first and second adjustment plates, and wherein the first and second bellcranks are pivotally coupled to the first and second adjustment plates, respectively.

4. The mower according to claim 1, wherein the connecting rod comprises both a core shaft and a cylindrical sleeve surrounding the core shaft, the sleeve rotatable about the core shaft.

5. The mower according to claim 1, further comprising a prime mover carried by the mower chassis and adapted to rotate the at least one rotary cutting blade.

6. The mower according to claim 1, further comprising a prime mover carried by the mower chassis and adapted to rotate one or both of the two wheels.

7. The mower according to claim 1, further comprising one or more prime movers carried by the mower chassis and adapted to rotate the at least one rotary cutting blade and one or both of the two wheels.

8. The mower according to claim 1, further comprising an upwardly and rearwardly extending operator handle assembly connected to the mower chassis.

9. A power lawn mower comprising:
a mower chassis supporting a cutting deck containing at least one powered rotary cutting blade, the blade defining a cutting plane;
two wheels operatively connected to the mower chassis and adapted to support the mower chassis in rolling engagement with a ground surface, wherein the two wheels include a first wheel located on a first side of the mower chassis, and a second wheel located on an opposite, second side of the mower chassis;
a height-of-cut (HOC) system adapted to adjust a height of the two wheels simultaneously relative to the mower chassis, thereby adjusting an elevation of the cutting blade relative to the ground surface in an HOC range between a maximum HOC position and a minimum HOC position, wherein the HOC system comprises:
first and second bellcranks located proximate the first and second wheels, respectively, wherein both of the bellcranks are pivotally coupled to the mower chassis such that both pivot about a common pivot axis extending transverse to a travel axis of the chassis, wherein each of the first and second bellcranks comprises: a first end spaced-apart from the common pivot axis and adapted to support a wheel axle of its associated first or second wheel; and a second end also spaced-apart from the common pivot axis; and
a connecting rod connected to the second ends of the first and second bellcranks such that pivotal motion of the first bellcrank about the common pivot axis produces corresponding pivotal motion of the second bellcrank about the common pivot axis,
wherein the first and second bellcranks are pivotable between a first position corresponding to the maximum HOC position, and a second position corresponding to the minimum HOC position, and wherein a lowermost portion of the connecting rod remains at an elevation between an elevation of the cutting plane and an elevation of the ground surface regardless of the position of the cutting blade within the HOC range.

10. The mower according to claim 9, wherein the lowermost portion of the connecting rod is spaced-apart from the ground surface by a distance of less than 50 millimeters when the connecting rod is at a lowermost position within the HOC range.

11. The mower according to claim 9, further comprising an electric propulsion motor adapted to drive first and second drive axles each having an axis that is coaxial with the common pivot axis.

12. The mower according to claim 11, wherein each of the first and second drive axles comprises a pinion gear, and wherein each pinion gear is adapted to mesh with a ring gear of its associated first or second wheel.

13. The mower according to claim 12, further comprising a differential operatively positioned between the electric propulsion motor and the first and second axles.
